(19) United States
(12) Patent Application Publication
(10) Pub. No.: US 2021/0116908 A1
(43) Pub. Date: Apr. 22, 2021

(54) Method and Apparatus for Remote Operation of Motorized Two-Wheeled Vehicle

(71) Applicants: Daniel Kee Young Kim, Portland, OR (US); David Arthur Bailey, Glendale, AZ (US)

(72) Inventors: Daniel Kee Young Kim, Portland, OR (US); David Arthur Bailey, Glendale, AZ (US)

(21) Appl. No.: 17/076,745

(22) Filed: Oct. 21, 2020

Related U.S. Application Data
(60) Provisional application No. 62/924,078, filed on Oct. 21, 2019.
(60) Provisional application No. 62/931,711, filed on Nov. 6, 2019.

(51) Int. Cl. G05D 1/00; G05D 1/02; G06Q 50/30

(52) U.S. Cl. CPC G05D 1/0038; G05D 1/0212; G06Q 50/30; G05D 1/0278; G05D 1/0016

(57) ABSTRACT

A method for autonomous control of transport of a two-wheeled motorized scooter or e-bike includes receiving at service provider's application via a communications network input that the scooter is parked, transmitting a communication from the service provider's application via the communications network to the scooter to request transport of the scooter to a location, and remotely piloting the scooter via the communications network from where it is parked to the location responsive to the request to transport the scooter to the location.

### CLAIM OF PRIORITY

This patent application is related, and claims priority, to provisional patent application No. 62/924,078 filed Oct. 21, 2019, entitled “Method and Apparatus for Remote Operation of Self-Balancing Motorized Two-Wheeled Vehicle”, the contents of which are incorporated herein by reference, and is related, and claims priority, to provisional patent application No. 62/931,711 filed Nov. 6, 2019, entitled “Method and Apparatus for Remote Operation of Motorized Two-Wheeled Vehicle”, the contents of which are incorporated herein by reference.

### TECHNICAL FIELD

Embodiments of the present invention relate to a motorized two-wheeled vehicle that can be remotely piloted.

### BACKGROUND

Motorized two-wheeled vehicles, for example, motorized scooters, whether seated or stand-up scooters, may need to be relocated, for example, returned to docking stations or base of operations for recharging or refueling (any storable energy transfer) and/or maintenance, returned to a depot or other convenient locations for subsequent use, for special events or in response to complaints. It is labor intensive to gather a fleet of motorized two-wheeled vehicles and return them to a base, or rental location, or distribute, disperse or rebalance them for subsequent use. Mobility startups are interested in reducing the quite costly operational challenges of recharging, repairing, and rebalancing their fleets, which currently require large support crews or amateur bounty hunters chasing financial incentives. In 2018, one of the largest scooter rental services, Bird, allegedly spent close to half its gross revenue per ride paying contractors to charge its e-scooters, and another 14 percent of that revenue for repairs. What is needed is a way to reduce the labor and associated costs of retrieving and/or returning motorized two-wheeled vehicles to a desired location.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 is depicts a system in accordance with an embodiment of the invention; and

FIG. 2 is a flow chart in accordance with an embodiment of the invention.

### DETAILED DESCRIPTION

Embodiments of the invention may be applied to a foldable scooter such as described in U.S. Pat. No. 8,388,005, the entire contents of which are incorporated herein by reference.

Embodiments of the invention may be applied to a self-balancing motorized two-wheeled vehicle, such as described in US patent publication US2019/0077480 A1, the entire contents of which are incorporated herein by reference. For example, embodiments of the invention may be applied to a foldable scooter as discussed above that incorporates the self-balancing technology described in US patent publication US2019/0077480 A1.

Embodiments of the invention may be applied to a self-balancing motorized two-wheeled vehicle that incorporates the capabilities of sensing and detecting terrain, environmental conditions, environmental objects, and assessing avoidance, and mitigation of vehicle collision, as described in U.S. Pat. No. 8,930,128, the entire contents of which are incorporated herein by reference.

Embodiments of the invention may be applied to a two wheeled scooter or e-bike that utilizes deployable—extendable and retractable—outrigger type arms with wheels at their ends, so that once deployed, that is, once engaged with, adjacent or near the surface on which the wheels of the scooter or e-bike rest, the outrigger type arms with wheels at their ends operate substantially similarly to training wheels on a bicycle, to maintain the scooter or e-bike in a substantially upright direction while stationary and while being transported. Some embodiments may use a single outrigger and some embodiments may use two or more outriggers to provide balance while stationary and/or transiting. Some embodiments may employ outriggers with low friction skids and, or rather than, wheels. Some embodiments use the skids to steer the vehicle when transiting to a destination.

Embodiments of the invention contemplate a last mile electric scooter service, provided by a scooter-sharing system such as Bird, or LimeBike, in which users share two-wheeled vehicles. These vehicles typically comprise stored energy which can be used to propel the vehicle or partially assist a rider in propelling the vehicle, or can be used to propel the vehicle autonomously, without any rider assistance or control. A scooter-sharing system is a service in which scooters are made available to use for short-term, perhaps for a small rental fee. The term describes the sharing of mostly electric motor scooters (also referred to as electric mopeds) as well as electric kick scooters. The sharing of scooters is similar to car sharing or bicycle-sharing systems; with some scooter-sharing companies offering more than one type of vehicle via their service.

Scooters are generally “dockless”, meaning that they do not have a fixed home location, and are dropped off and picked up from arbitrary locations in the service area. This generally makes them a convenient mobility option for first-/last-mile mobility in urban areas. A user may access a scooter, for example, by unlocking it with a QR code, enter his/her authorization for manual operation of the scooter and then drive to the user's desired destination. At the destination, the rider sets aside the scooter.

According to embodiments, a method for autonomous control of transport of a two-wheeled motorized scooter or e-bike is provided which includes receiving at service provider's application via a communications network input that the scooter is parked, transmitting a communication from the service provider's application via the communications network to the scooter to request transport of the scooter to a location, remotely piloting the scooter via the communications network from where it is parked to the location responsive to the request to transport the scooter to the location.

In such embodiments, transmitting the communication from the service provider's application via the communications network to the scooter to request transport of the scooter to the location comprises transmitting the communication from the service provider's application via the communications network to the scooter to request transport of the scooter to a new location.

Further in such embodiments, receiving over the communications network input that the scooter is parked comprises receiving over the communications network input a current location at which the scooter is parked.

In such embodiments, transmitting the communication from the service provider's application via the communications network to the scooter to request transport of the scooter to the location comprises transmitting the communication from the service provider's application via the communications network to the scooter to request transport of the scooter to a location selected from a group of locations consisting of: a home base location, a charging station location, a maintenance location, a location selected to rebalance a plurality of locations at which a fleet of scooters, including the scooter, are available for use.

According to the embodiments, remotely piloting the scooter via the communications network from where it is parked to the location responsive to the request to transport the scooter to the location comprises receiving one or both of a user input or an autonomous driving application input as to where to pilot the scooter from where it is parked to the location.

Further according to the embodiments, remotely piloting the scooter via the communications network from where it is parked to the location responsive to the request to transport the scooter to the location comprises establishing a video-telephony communication between the scooter and a remote control piloting application, receiving at the remote control piloting application image data captured from one or more cameras coupled to the scooter, and transmitting control data from the remote control piloting application to the scooter to direct the path over which to transport the scooter from where it is parked to the location, in part based on the captured image data received at the remote control piloting application. Receiving at the remote control piloting application image data captured from one or more cameras coupled to the scooter further comprises, according to one embodiment, receiving at the remote control piloting application audio data captured from one or more audiovisual cameras coupled to the scooter. Further, transmitting control data from the remote control piloting application to the scooter to direct the path over which to transport the scooter from where it is parked to the location, in part based on the captured image data received at the remote control piloting application comprises transmitting control data from the remote control piloting application to the scooter to direct the path over which to transport the scooter from where it is parked to the location, in part based on the captured audio data received at the remote control piloting application.

Embodiments further comprise receiving user input via a peripheral device. In such embodiments, transmitting control data from the remote control piloting application to the scooter to direct the path over which to transport the scooter from where it is parked to the location, in part based on the captured image data received at the remote control piloting application comprises transmitting control data from the remote control piloting application to the scooter to direct the path over which to transport the scooter from where it is parked to the location, in part based on the captured image data received at the remote control piloting application and in part based on the received user input. Receiving user input via a peripheral device comprises receiving audible user input via a microphone, or receiving written commands via a keyboard, or receiving directional commands via a trackpad or joystick or touch screen.

Transmitting control data from the remote control piloting application to the scooter to direct the path over which to transport the scooter from where it is parked to the location comprises, in one embodiment, transmitting control data from the remote control piloting application to steering actuators and a GPS embodied in the scooter to direct the path over which to transport the scooter from where it is parked to the location.

Certain embodiments confirm the scooter is in an upright position prior to remotely piloting the scooter via the communications network from where it is parked to the location responsive to the request to transport the scooter to the location. Additional embodiments confirm one or more outrigger wheels of the scooter are in contact with a surface prior to remotely piloting the scooter via the communications network from where it is parked to the location.

According to an embodiment, user input may be received via a mobile application in communication with the service provider's application via the communications network, the user input requesting delivery of the scooter to the location. In one embodiment, receiving user input via the mobile application in communication with the service provider's application via the communications network requesting delivery of the scooter to the location comprises receiving user input via the mobile application in communication with the service provider's application via the communications network, the user input requesting delivery of the scooter to the location at a requested date and time, or within a selected period of time thereof.

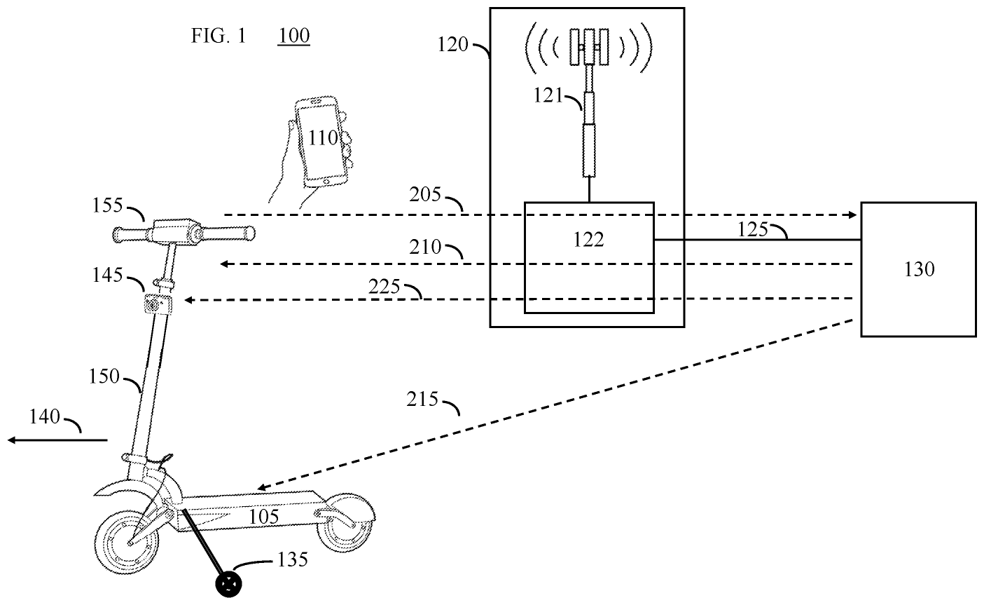

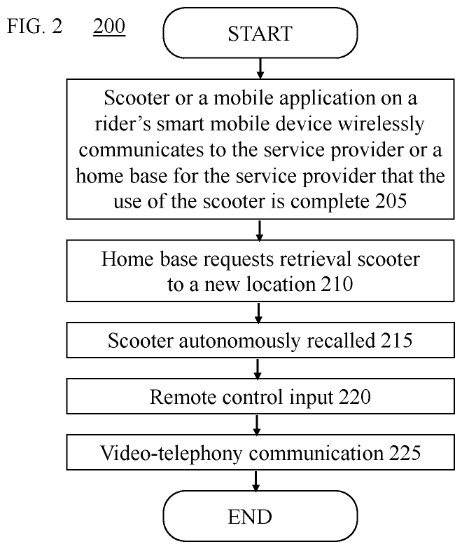

With reference to an embodiment of the invention 100 depicted in FIG. 1, and the flow chart 200 of the embodiment of the invention provided in FIG. 2, one embodiment involves at block 205 the scooter 105 or a mobile application 110 on a rider's smart mobile device wirelessly communicating, for example, via cellular system 120 (comprising one or more cellular mobile network antennas 121 and mobile switching centers 122) and network 125 (e.g., the Internet or a private network) to a service provider (e.g., cloud based service provider) or a home base for the service provider 130 that the use of the scooter is complete, the rider's ride has ended, the scooter is idle, parked, and unmanned. In one embodiment, the communication provides location information for the scooter.

The service provider 130 then, at block 210, depending on the existing location of the scooter, transmits a request to retrieve or recall, the scooter, to a new location, for example, the home base, a charging station, a maintenance location, etc. At block 215, the scooter is autonomously recalled, that is, without an operator having to manually haul or operate the scooter, using self-balancing motorized two-wheeled technology, or using extendable and retractable outrigger type arms with wheels at the end as depicted at 135. The two-wheeled device is driven, per the recall instruction, in a particular direction as depicted at 140, at a low speed, via a remote control piloting or driving application. The remote control driving application may be a component of the service provider's application, or a separate application that communicates with the service provider's application to receive notification of the request to transport the scooter to a new location, and then communicates via the communication network with the scooter, either directly or via the service provider's application, to autonomously control transport of the scooter from where it is parked to a selected location.

The direction of the motorized scooter 105, depicted at 140, is controlled by remote control input 220 (e.g., remotely piloted by an operator or an autonomous driving application) received by the remote control piloting or driving application. The remote control piloting or driving application, whether based on input from a human operator or an from an autonomous driving application, communicates with the motorized two-wheeled vehicle over the communications network 120, such as a 4G mobile communications network (e.g., LTE), or a “5G” wireless communications network that meets the requirements of ITU IMT-2020 or the industry association 3GPP to direct the path over which the scooter is transported from where it is parked to the selected location. Of course, other wireless communication networks, such as satellite and/or GPS networks may alternatively or additionally be used to communicate between the remote pilot and the motorized two-wheeled vehicle.

According to one embodiment, the remote control piloting application further communicates at block 225 with the motorized two-wheeled vehicle 105 via a video-telephony application, such as FaceTime, a proprietary video-telephony product developed by Apple Inc. It is contemplated other video-telephony or video chat applications, such as Viber, Facebook Messenger, WhatsApp, or other video-telephony applications supported on computing platforms such as Microsoft Windows, macOS, Linux, Andriod, iOS, etc., may also be used. In such an embodiment, the motorized two-wheeled vehicle is equipped with at least a forward-facing camera 145, a single camera rotatably mounted, or multiple cameras, so as to provide up to 360 degree audio-video coverage, and further equipped with a video codec, one or more CPUs, and a mobile telephony interface (none shown), all communicably coupled to the camera 145, and, for example, all housed in the vertical stem 150 of the T-bar handlebar 155 of the scooter, to provide high quality low-cost audiovisual service between the vehicle and the remote pilot from almost any place in the world that the Internet and mobile communications are available. For example, the remote pilot might be operating somewhere on the other side of the globe from where, or within the same urban area in which, the motorized two-wheeled vehicle is located.

In this manner, a remote pilot can establish a video-telephony session with the motorized two-wheeled vehicle and at least visibly navigate the motorized two-wheeled vehicle to a destination selected by the remote pilot. It is also possible the remote pilot can, via the established video-telephony session, additionally or alternatively navigate the motorized two-wheeled vehicle using audible commands or commands entered via one or more input devices, such as a keyboard, trackpad, or touch screen. In addition to live feed video and object detection, embodiments of the invention employ steering actuators and may use GPS to guide a scooter, for example, back to a docking station.

According to an embodiment, to initiate the remote piloting of a two-wheeled scooter, for instance, to return the scooter to a docking station, the remote pilot verifies that the scooter is in a returnable configuration (e.g., upright) and environment (e.g., a drivable surface). This may be accomplished by way of receiving and viewing image data captured by an onboard camera, or receiving sensor data from one or more onboard motion sensors such as an accelerometer.

If the two-wheeled scooter is self-balancing, the remote pilot then brings the momentum wheel to its operational speed. If the scooter uses one or more outriggers with wheel (135) for balance, the outriggers and wheels keeps the scooter balanced while the remote pilot guides the scooter safely to the docking station, e.g., for recharging. The remote pilot cannot initiate scooter retrieval or movement if it is not an upright position, or its wheels not in contact with a suitable surface. This may be accomplished by way of receiving and viewing image data captured by an onboard camera, or receiving sensor data from one or more onboard sensors such as a capacitive sensor that senses an electrical charge suggesting a wheel is in contact with earth, that is, the wheel is grounded. The scooter includes a means, such as CMGs for self-balancing, or outrigger wheels, to maintain the scooter in an upright position, to prevent overturn of the scooter, so that retrieval is possible.

According to one embodiment, a rider can request a scooter to be delivered now or schedule delivery of a scooter at a particular time. The scooter is driven by the same autonomous system described above that is used to recall or retrieve the scooter, to transport the scooter to the requested location at the requested time. When the rider takes control, the CMG may be turned off or the rider releases the outrigger wheels, as the case may be, and the rider rides the motorized two-wheeled vehicle in the traditional way.

The invention embodies systems, techniques and algorithms for the autonomous movement of the scooter between predetermined geographic locations. Some embodiments of the invention include a time of arrival specification providing for the motorized two-wheeled vehicle to arrive at its destination at a particular time. Such an embodiment may receive user input via a mobile application in communication with the service provider's application via the communications network, the user input requesting delivery of the scooter to the location.

In one embodiment, the received user input further requests delivery of the scooter to a location at a requested date and time, or within a selected period of time thereof.

The invention embodies a navigation system which determines and controls the location, velocity and direction of the two-wheeled vehicle. Many combinations of sensors, transponders, radio receivers and transducers may be installed on the motorized vehicle for use by the navigation system. According to such an embodiment, the remote pilot operates the motorized two-wheeled vehicle at appropriate speeds, and over appropriate terrain/routes for the environment. For example, the remote pilot might navigate the motorized two-wheeled vehicle to a destination via a combination of one or more available roads, vehicle lanes, bike lanes, pedestrian or bike paths, the side or shoulder of roads, etc., depending on the route selected by the navigation system, taking into consideration the time of day, weather, road conditions, traffic conditions, traffic congestion, scooter condition, or rider's needs or requests.

Embodiments of the invention include algorithms to calculate a best path between the starting location and the destination location for a scooter. Some embodiments of the algorithm utilize geolocation data and digital maps to determine the path between the starting location and the destination location. Some embodiments utilize visual or multispectral imagery including but limited to the visual, infrared, and ultraviolet bands of light to identify a path from the starting location to the destination location. Some embodiments utilize an inertial measurement unit to guide the path from starting location to the destination location. Of course, embodiments may use combinations of geolocation, inertial measurement and visual sensors for guidance.

Embodiments of the system may include a collision avoidance system of sensors and algorithms to avoid collisions with objects and persons along the path from the departure location to the destination location. Some embodiments of the collision avoidance system include a human/remote pilot in the control loop to make real-time decisions for collision avoidance. Such embodiments utilize the cameras and radio networks discussed above to present an image stream or continuous video to the remote pilot to allow the remote pilot to make local steering corrections along the path to avoid collisions.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

An electronic device according to some example implementations includes hardware comprising a set of one or more processor(s), a set of one or more network interfaces (wireless and/or wired), and machine-readable media having stored therein software (which includes instructions executable by the set of one or more processor(s). The machine-readable media may include non-transitory and/or transitory machine-readable media. Each of the previously described clients and the embodiments of the invention may be implemented in one or more electronic devices. In one implementation: 1) each of the clients is implemented in a separate one of the electronic devices (e.g., in end user devices where the software represents the software to implement clients to interface directly and/or indirectly with the service provided by embodiments of the invention; 2) the service according to embodiments of the invention is implemented in a separate set of one or more of the electronic devices (e.g., a set of one or more server devices where the software represents the software to implement the service according to embodiments of the invention); and 3) in operation, the electronic devices implementing the clients and the service according to embodiments of the invention would be communicatively coupled (e.g., by a network) and would establish between them (or through one or more other layers and/or or other services) connections for submitting information to the service according to embodiments of the invention and returning information to the clients. Other configurations of electronic devices may be used in other implementations (e.g., an implementation in which the client and the service according to embodiments of the invention are implemented on a single electronic device).

Alternative implementations of an electronic device may have numerous variations from that described above. For example, customized hardware and/or accelerators might also be used in an electronic device.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

1. A method for autonomous control of transport of a two-wheeled motorized scooter or e-bike, comprising:
receiving at service provider's application via a communications network input that the scooter is parked;
transmitting a communication from the service provider's application via the communications network to the scooter to request transport of the scooter to a location; and
remotely piloting the scooter via the communications network from where it is parked to the location responsive to the request to transport the scooter to the location.

2. The method of claim 1, wherein transmitting the communication from the service provider's application via the communications network to the scooter to request transport of the scooter to the location comprises transmitting the communication from the service provider's application via the communications network to the scooter to request transport of the scooter to a new location; and
wherein receiving over the communications network input that the scooter is parked comprises receiving over the communications network input a current location at which the scooter is parked.

3. The method of claim 1, wherein transmitting the communication from the service provider's application via the communications network to the scooter to request transport of the scooter to the location comprises transmitting the communication from the service provider's application via the communications network to the scooter to request transport of the scooter to a location selected from a group of locations consisting of: a home base location, a charging station location, a maintenance location, a location selected to rebalance a plurality of locations at which a fleet of scooters, including the scooter, are available for use.

4. The method of claim 1, wherein remotely piloting the scooter via the communications network from where it is parked to the location responsive to the request to transport the scooter to the location comprises receiving one or both of a user input or an autonomous driving application input as to where to pilot the scooter from where it is parked to the location.

5. The method of claim 1, wherein remotely piloting the scooter via the communications network from where it is parked to the location responsive to the request to transport the scooter to the location comprises:
establishing a video-telephony communication between the scooter and a remote control piloting application;
receiving at the remote control piloting application image data captured from one or more cameras coupled to the scooter; and
transmitting control data from the remote control piloting application to the scooter to direct the path over which to transport the scooter from where it is parked to the location, in part based on the captured image data received at the remote control piloting application.

6. The method of claim 5, wherein receiving at the remote control piloting application image data captured from one or more cameras coupled to the scooter further comprises receiving at the remote control piloting application audio data captured from one or more audiovisual cameras coupled to the scooter; and
wherein transmitting control data from the remote control piloting application to the scooter to direct the path over which to transport the scooter from where it is parked to the location, in part based on the captured image data received at the remote control piloting application comprises transmitting control data from the remote control piloting application to the scooter to direct the path over which to transport the scooter from where it is parked to the location, in part based on the captured audio data received at the remote control piloting application.

7. The method of claim 5, further comprising receiving user input via a peripheral device; and
wherein transmitting control data from the remote control piloting application to the scooter to direct the path over which to transport the scooter from where it is parked to the location, in part based on the captured image data received at the remote control piloting application comprises transmitting control data from the remote control piloting application to the scooter to direct the path over which to transport the scooter from where it is parked to the location, in part based on the captured image data received at the remote control piloting application and in part based on the received user input.

8. The method of claim 7, wherein receiving user input via a peripheral device comprises receiving audible user input via a microphone, or receiving written commands via a keyboard, or receiving directional commands via a trackpad or joystick or touch screen.

9. The method of claim 5, wherein transmitting control data from the remote control piloting application to the scooter to direct the path over which to transport the scooter from where it is parked to the location comprises transmitting control data from the remote control piloting application to steering actuators and a GPS embodied in the scooter to direct the path over which to transport the scooter from where it is parked to the location.

10. The method of claim 1, wherein prior to remotely piloting the scooter via the communications network from where it is parked to the location responsive to the request to transport the scooter to the location, the method further comprising confirming the scooter is in an upright position.

11. The method of claim 1, wherein prior to remotely piloting the scooter via the communications network from where it is parked to the location responsive to the request to transport the scooter to the location, the method further comprising confirming one or more outrigger wheels of the scooter are in contact with a surface.

12. The method of claim 1, further comprising:
receiving user input via a mobile application in communication with the service provider's application via the communications network, the user input requesting delivery of the scooter to the location.

13. The method of claim 12, wherein receiving user input via the mobile application in communication with the service provider's application via the communications network requesting delivery of the scooter to the location comprises receiving user input via the mobile application in communication with the service provider's application via the communications network, the user input requesting delivery of the scooter to the location at a requested date and time, or within a selected period of time thereof.
